(19) United States
(12) Patent Application Publication
(10) Pub. No.: US 2015/0042809 A1
(43) Pub. Date: Feb. 12, 2015

(54) ANTI-THEFT ALARM SYSTEM

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: CHIN-WEN YEH, New Taipei (TW); YANG XIAO, Wuhan (CN)

(21) Appl. No.: 14/456,300

(22) Filed: Aug. 11, 2014

(30) Foreign Application Priority Data
Aug. 12, 2013 (CN) 2013103479494

(51) Int. Cl. G08B 13/181; H04N 7/18

(52) U.S. Cl. CPC G08B 13/181; H04N 7/183
USPC 348/150; 340/568.1

(57) ABSTRACT

An anti-theft alarm system for a vending machine includes an infrared sensor, an alarm device, and a processing unit. When the infrared sensor detects an object passing through a product exit port of the vending machine, the processing unit controls the alarm device to emit an alarm to draw attention to proximate persons around the vending machine. An anti-theft alarm method for a vending machine is also disclosed.

### CROSS-REFERENCE TO RELATED APPLICATIONS

This application claims priority to China Patent Application No. 201310347949.4 filed on Aug. 12, 2013 in the State Intellectual Property Office of China, the contents of which are hereby incorporated by reference.

### FIELD

The disclosure generally relates to alarm systems, and more particularly relates to anti-theft alarm systems for a vending machine.

### BACKGROUND

Vending machines have been in common use for vending a variety of items such as snacks, beverages, alcohol, cigarettes, lottery tickets, cologne, consumer products, and even gold and gems. However, the vending machines are often placed in an unattended place, which may bring a theft problem that the products stored in the vending machines are illegitimately taken by unauthorized persons.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an embodiment of an anti-theft alarm system for a vending machine.

FIG. 2 is a flowchart of an embodiment of a method for controlling an infrared sensor based on a state of a central control door of a vending machine.

FIG. 3 is a flowchart of one embodiment of a method for controlling an infrared sensor based on a state of a vending transaction of a vending machine.

FIG. 4 is a flowchart of one embodiment of an anti-theft alarm method for a vending machine.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

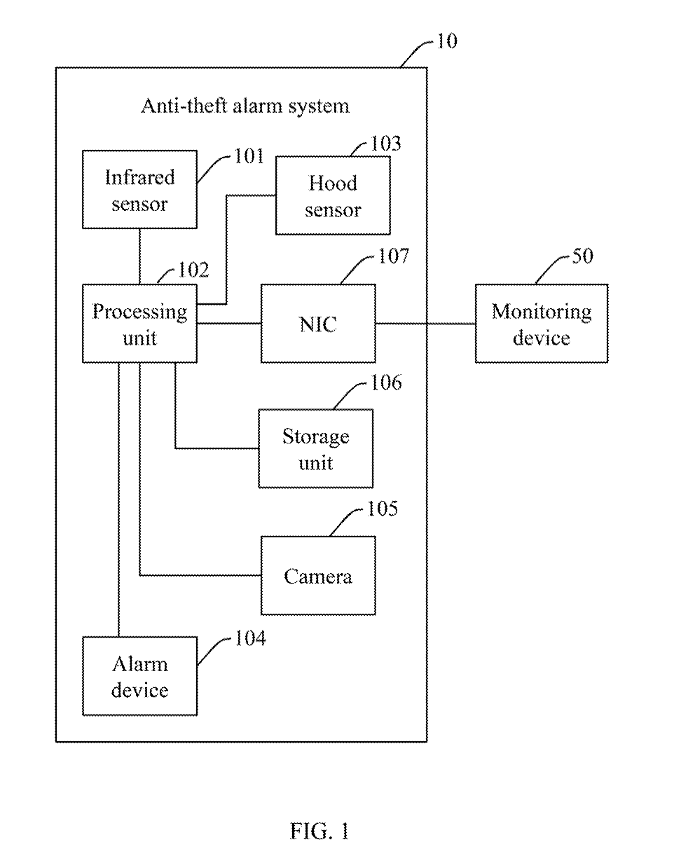

FIG. 1 illustrates an embodiment of an anti-theft alarm system 10 for a vending machine. The anti-theft alarm system 10 includes an infrared sensor 101, a processing unit 102, a hood sensor 103, an alarm device 104, a camera 105, a storage unit 106, and a network interface controller (NIC) 107.

The infrared sensor 101 can be located in a product exit port of the vending machine. The infrared sensor 101 can be turned on to detect whether an object passes through the product exit port from inside to outside of the vending machine, or from outside to inside of the vending machine. The infrared sensor 101 can be turned off when payment is received to purchase a product from the vending machine. The infrared sensor 101 is coupled to the processing unit 102. When the infrared sensor 101 is turned on and detects that an object passes through the product exit port, the infrared sensor 101 can transmit a report signal to the processing unit 102.

The processing unit 102 can be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein.

The hood sensor 103 is coupled to the processing unit 102. The hood sensor 103 can detect a state of a central control door of the vending machine. In this embodiment, the state can be open or closed. In the embodiment, when the state of the central control door is open, the vending machine is undergoing maintenance work, and the infrared sensor 101 is turned off. When the state of the central control door is closed, the infrared sensor 101 is turned on. The hood sensor 103 can transmit the state of the central control door of the vending machine to the processing unit 102, and the processing unit 102 can turn on or turn off the infrared sensor 101.

The alarm device 104 and the camera 105 are coupled to the processing unit 102. The alarm device 104 can be a visual alarm device, such as a strobe light, which can flash light, or an audible alarm device, such as a loudspeaker, which can produce sound. The camera 105 can record images of surroundings of the vending machine. The images can be photographs, or moving images such as videos. In some embodiments, the camera 105 can record videos with sound.

The storage unit 106 is coupled to the processing unit 102, such that the processing unit 102 can read information from, and write information to, the storage unit 106. The storage unit 106 can be realized as RAM memory, flash memory, EPROM memory, EEPROM memory, registers, a hard disk, a removable disk, a CD-ROM, or any other form of storage medium known in the art. The images recorded by the camera 105 can be stored in the storage unit 106.

The NIC 107, also known as a network adapter, can enable the anti-theft alarm system 10 to communicate over an Internet Protocol (IP) network, such as a local area network (LAN) or the Internet.

When the infrared sensor 101 is turned on and detects that an object passes through the product exit port of the vending machine, the infrared sensor transmits a report signal to the processing unit 102. In response to receiving the report signal, the processing unit 102 controls the alarm device 104 to emit an alarm to draw attention to proximate persons around the vending machine, and controls the camera 105 to record images of the surroundings of the vending machine.

In at least one embodiment, the anti-theft alarm system 10 can communicate with a remotely-located monitoring device 50 via an IP network. When the processing unit 102 receives the report signal from the infrared sensor 101, the processing unit 102 can transmit an alarm message to the monitoring device 50. When the monitoring device 50 receives the alarm message, the monitoring device 50 can provide a visible or audible interface to inform a user of the monitoring device 50. The monitoring device 50 can be, but is not limited to, a personal computer, a server computer, a tablet computer, a personal digital assistant (PDA), a smart phone, or any other type of portable or non-portable electronic device.

When the processing unit 102 receives the report signal from the infrared sensor 101, the processing unit 102 can further retrieve the recorded images from the storage unit 106, and transmit the recorded images to the monitoring device 50 via the IP network.

When the processing unit 102 receives a payment accepted signal from a payment approval unit (not shown) of the vending machine, the processing unit 102 turns off the infrared sensor 101, so that a product can pass though the product exit port without causing the infrared sensor 101 to transmit a report signal to the processing unit 102. After the product passes through the product exit port, the processing unit 102 can receive a transaction completed signal from a transaction control unit (not shown) of the vending machine, and the processing unit 102 turns on the infrared sensor 101.

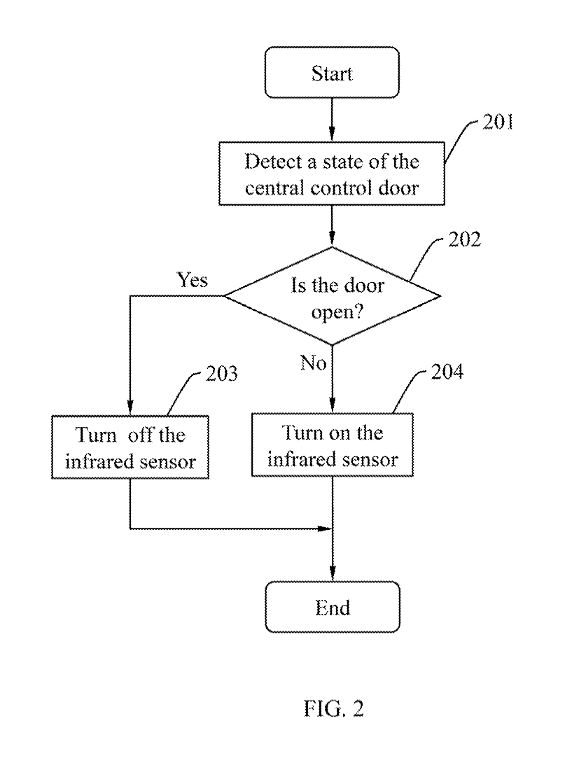

FIG. 2 illustrates a flowchart of one embodiment of a method for controlling an infrared sensor based on a state of a central control door of a vending machine. The method includes the following steps.

In block 201, a hood sensor detects the state of the central control door of the vending machine.

In block 202, if the central control door of the vending machine is open, block 203 is implemented. Otherwise, if the central control door is closed, block 204 is implemented.

In block 203, a processing unit 102 determines that the vending machine is undergoing maintenance and turns off the infrared sensor.

In block 204, the processing unit 102 turns on the infrared sensor 101.

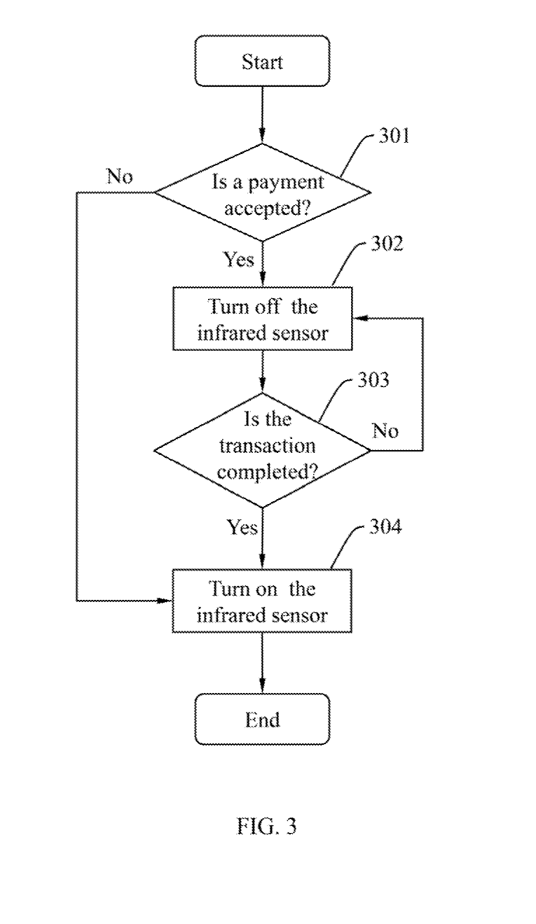

FIG. 3 illustrates a flowchart of one embodiment of a method for controlling an infrared sensor based on a state of a vending transaction of a vending machine. The method includes the following steps.

In block 301, if a processing unit 102 receives a payment accepted signal from a payment approval unit of the vending machine, block 302 is implemented. If the processing unit does not receive the payment accepted signal, block 304 is implemented.

In block 302, the processing unit 102 turns off the infrared sensor 101.

In block 303, if the processing unit 102 receives a transaction completed signal from a transaction control unit of the vending machine, block 304 is implemented. If the processing unit 102 does not receive the transaction completed signal, block 302 is implemented.

In block 304, the processing unit 102 turns on the infrared sensor 101.

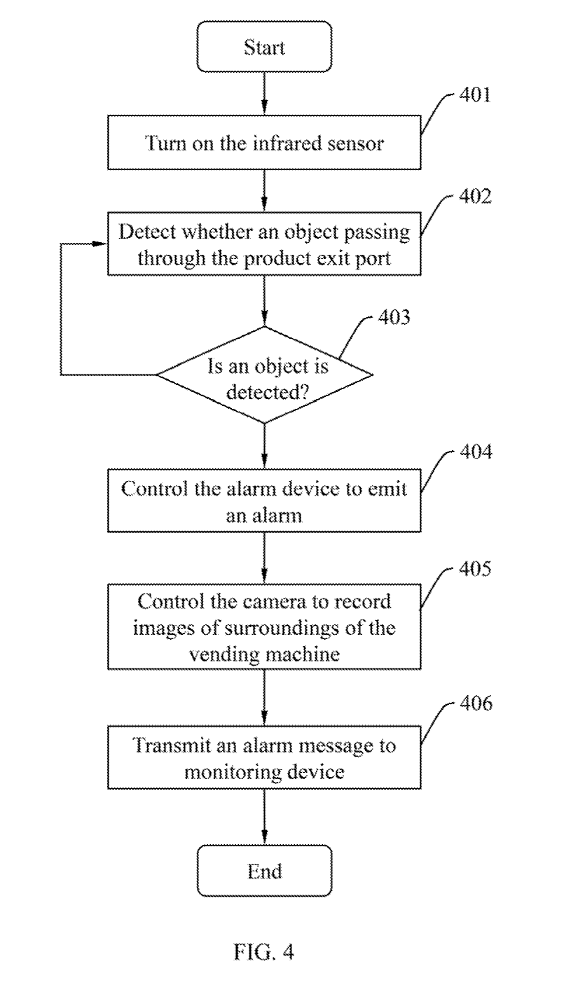

FIG. 4 illustrates a flowchart of one embodiment of an anti-theft alarm method for a vending machine. The method includes the following steps.

In block 401, a processing unit turns on an infrared sensor.

In block 402, the infrared sensor detects whether an object passes through a product exit port of the vending machine.

In block 403, if the infrared sensor detects an object passing through the product exit port of the vending machine, block 404 is implemented. Otherwise, if the infrared sensor does not detect an object passing through the product exit port, block 402 is implemented.

In block 404, the processing unit controls an alarm device to emit an alarm to draw attention to proximate persons around the vending machine.

In block 405, the processing unit controls a camera to record images of surroundings of the vending machine, and stores the recorded images in a storage unit.

In block 406, the processing unit transmits an alarm message to a monitoring device via an IP network. The processing unit further retrieves the recorded images from the storage unit, and transmits the recorded images to the monitoring device.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

Although numerous characteristics and advantages have been set forth in the foregoing description of embodiments, together with details of the structures and functions of the embodiments, the disclosure is illustrative only, and changes may be made in detail, including in the matters of arrangement of parts within the principles of the disclosure. The disclosed embodiments are illustrative only, and are not intended to limit the scope of the following claims.

What is claimed is:

1. An anti-theft alarm system for a vending machine, the system comprising:
an infrared sensor located in a product exit port of the vending machine and configured to detect whether an object passes through the product exit port;
an alarm device; and
a processing unit coupled to the infrared sensor and the alarm device, the processing unit configured to control the alarm device to emit an alarm when the infrared sensor detects that an object passes through the product exit port.

2. The anti-theft alarm system of claim 1, wherein the processing unit is further configured to transmit an alarm message to a remotely located monitoring device via a network when the infrared sensor detects that an object passes through the product exit port.

3. The anti-theft alarm system of claim 1, further comprising a camera, wherein the processing unit is further configured to control the camera to record images of surroundings of the vending machine when the infrared sensor detects that an object passes through the product exit port.

4. The anti-theft alarm system of claim 3, wherein the processing unit is further configured to transmit the recorded images to a remotely located monitoring device via a network.

5. The anti-theft alarm system of claim 1, wherein the processing unit is further configured to turn off the infrared sensor when the processing unit receives a payment accepted signal from a payment approval unit of the vending machine.

6. The anti-theft alarm system of claim 5, wherein the processing unit is further configured to turn on the infrared sensor when the processing unit receives a transaction completed signal from a transaction control unit of the vending machine.

7. The anti-theft alarm system of claim 1, further comprising a hood sensor configured to detect a state of a central control door of the vending machine, wherein the processing unit is further configured to turn off the infrared sensor when the hood sensor detects that the central control door is open.

8. The anti-theft alarm system of claim 7, wherein the processing unit is further configured to turn on the infrared sensor when the hood sensor detects that the central control door is closed.

9. An anti-theft alarm method for a vending machine, the method comprising:
detecting whether an object passes through a product exit port of the vending machine by an infrared sensor; and
controlling an alarm device to emit an alarm by the processing unit when the infrared sensor detects that an object passes through the product exit port.

10. The anti-theft alarm method of claim 9, further comprising:
transmitting an alarm message to a remotely located monitoring device via a network when the infrared sensor detects that an object passes through the product exit port.

11. The anti-theft alarm method of claim 9, further comprising:
controlling a camera to record images of surroundings of the vending machine when the infrared sensor detects that an object passes through the product exit port.

12. The anti-theft alarm method of claim 11, further comprising:
transmitting the recorded images to a remotely located monitoring device via a network.

13. The anti-theft alarm method of claim 9, further comprising:
turning off the infrared sensor when the processing unit receives a payment accepted signal from a payment approval unit of the vending machine.

14. The anti-theft alarm method of claim 13, further comprising:
turning on the infrared sensor when the processing unit receives a transaction completed signal from a transaction control unit of the vending machine.

15. The anti-theft alarm method of claim 9, further comprising:
detecting a state of a central control door of the vending machine by a hood sensor; and
turning off the infrared sensor when the hood sensor detects that the central control door is open.

16. The anti-theft alarm method of claim 15, further comprising:
turning on the infrared sensor when the hood sensor detects that the central control door is closed.
